(19) United States
(12) Patent Application Publication
(10) Pub. No.: US 2006/0004943 A1
(43) Pub. Date: Jan. 5, 2006

(54) Computer system for interleave memory accessing among a plurality of nodes

(76) Inventors: Takashi Miyata, Zama (JP); Nobuo Yagi, Machida (JP); Shisei Fujiwara, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/167,181

(22) Filed: Jun. 28, 2005

(30) Foreign Application Priority Data
Jun. 30, 2004 (JP) 2004-194565

(51) Int. Cl. G06F 12/00

(52) U.S. Cl. 711/5; 711/156; 711/148

(57) ABSTRACT

Destination registers are provided in a chipset and node information is set in the destination registers. The destination address is selected in accordance with a physical address to be accessed to thereby decided a node provided with a memory to be accessed. The magnitude of the load of the memory access to the node can be changed in accordance with setting of the node information in the destination registers. Optimum node information can be set in the destination registers in accordance with the number of nodes increased and the transfer speed and the capacity of the memory to thereby increase the flexibility and uniform the throughput of memory access to each node.

### BACKGROUND OF THE INVENTION

The present invention relates to a computer system for realizing memory interleaving among a plurality of nodes.

With the rapid improvement of the processor performance in recent years, the occupancy rate of the latency in the memory access to the whole processing time of a computer system is increased. Thus, in order to prevent the latency in the memory access from being a bottleneck of the system performance, the memory interleaving system is used.

In the memory interleaving, the localization of the memory access that continuous areas are often accessed in order is utilized to assign successive addresses to memories provided in a plurality of nodes alternately so that the access to a plurality of memories is made in parallel to disperse the load of the memory access.

In a conventional system, one to a plurality of bits of a physical address are decoded to thereby decide the node provided with a memory to be accessed. Accordingly, the load of the memory access to each node is uniform, so that the load of the memory access cannot be changed in each node. For example, when the physical address is one bit, the physical bit is repeated to “0” and “1”, so that nodes 0 and 1 are accessed in order to thereby uniform the load.

When nodes are increased in a machine which includes two nodes and realizes memory interleaving, it is required to increase the nodes in the unit of the power of 2 in a conventional system (the nodes are decided in accordance with the bit number of the physical address and, for example, 4 nodes are increased for the bit number of 2 and 8 nodes are increased for the bit number of 3). Since the throughput of the memory access to each node is not uniform if the nodes are not increased in the unit of the power of 2, satisfactory memory interleaving effect cannot be attained. Further, even if memories provided in nodes to be increased do not have the same capacity and transfer speed as those of the memory provided in the existing system, the throughput of the memory access to each node is not uniform and accordingly satisfactory memory interleaving effect cannot be attained.

More particularly, new nodes are increased in the existing system which realizes memory interleaving, it is necessary to increase at least two nodes provided with the memories having the same capacity and transfer speed in order to uniform the throughput of the memory access to each node.

The above-mentioned prior art that the nodes are increased in the unit of the power of 2 with the equal capacity is disclosed in JP-A-9-179778. This publication discloses that even in the system in which memory boards having different capacities are mixed, memory interleaving can be made by defining the memory boards having the same capacity as a group.

### SUMMARY OF THE INVENTION

In a memory interleaving system containing the system disclosed in the above-mentioned publication, the memory access to each node is uniform and accordingly it is necessary to make identical the capacity and transfer speed of the memories provided in each node in order to uniform the throughput of the memory access to each node and attain the satisfactory memory interleaving effect. Further, since it is necessary to increase nodes in the unit of the power of 2, there is a need for flexibility in increase of nodes and memory structure.

It is an object of the present invention to provide a system for making memory interleaving among a plurality of nodes and which can realize increase of nodes and memory structure with high flexibility.

In order to solve the above problems, according to the present invention, in a computer system for making memory interleaving among a plurality of nodes, the nodes each comprise a CPU, a memory and a controller for controlling transmission and reception of data between the CPU and the memory and between each node and outside and the controller of each node comprises a plurality of destination registers for setting node information for said plurality of nodes containing its own node and a selector for selecting one of the plurality of destination registers in accordance with a memory address of a memory access request issued by the CPU of its own node, the memory access request being issued to the node selected by said selector.

Further, in the computer system, when a node provided with a memory having transfer speed and capacity different from those of a memory provided in an existing node is increased, the controller controls setting of the node information for the increased node in the destination register to thereby uniform throughput of memory access to each node containing the increased node. When a node with a memory having transfer speed and capacity both increased N times is increased, the controller can set mode information for the increased node in N designation registers, where N is an integer larger than one.

According to the present invention, even when one node is increased, the throughput of the memory access to each node can be uniformed and satisfactory memory interleaving effect can be attained.

### BRIEF DESCRIPTION OF THE DRAWINGS

FIG. 1 is a block diagram illustrating a basic configuration of a multi-node server which realizes memory interleaving;

FIG. 2 is a block diagram schematically illustrating a memory interleaving system according to an embodiment of the present invention in which one node is increased;

FIG. 3 is a schematic diagram illustrating a decision procedure of a destination node in the memory interleaving system according to the embodiment of the present invention;

FIG. 4 is a block diagram schematically illustrating a memory interleaving system according to another embodiment of the present invention in which one node is increased; and

FIG. 5 is a flowchart showing a procedure for accessing a memory in the memory interleaving system according to the embodiment of the present invention.

### DESCRIPTION OF EMBODIMENTS

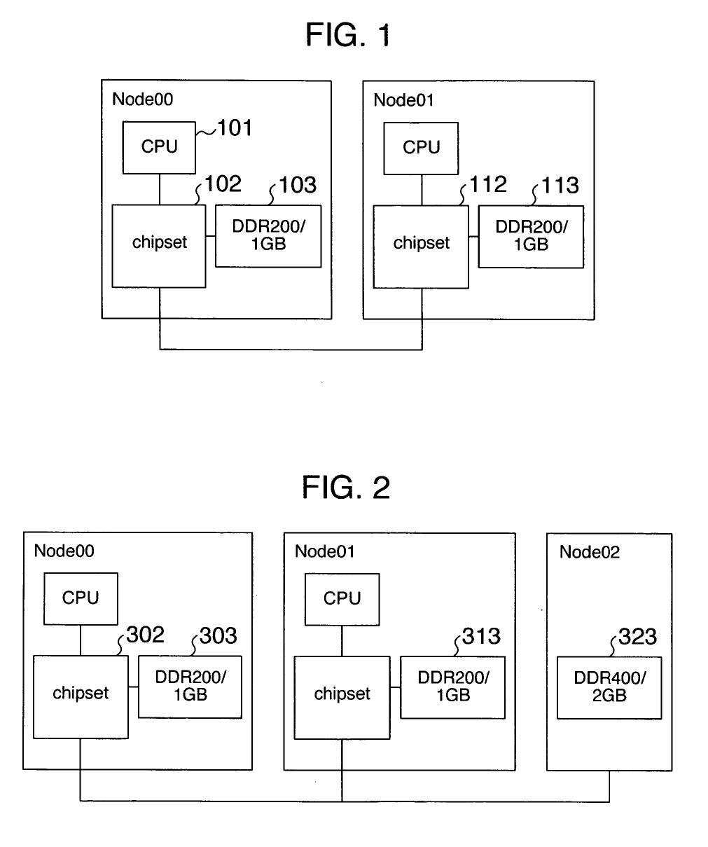

Referring now to FIGS. 1 to 5, a memory interleaving system according to an embodiment of the present invention is described in detail.

As shown in FIG. 1, an example of increasing a node in the memory interleaving system according to the embodiment applied to a multi-node server of a basic configuration which realizes memory interleaving is described as compared with an example of increase of nodes in the conventional system.

In FIG. 1, a memory access request issued by a CPU 101 of a node 00 is received by a chipset 102 which controls transmission and reception of data between the CPU and another node 01 and between the CPU and a main memory (e.g. DDR (double data rate) 200 MHz/1 GB memory) 103. The chipset 102 which receives the memory access request decides a node provided with a memory to be accessed from a physical address.

When the memory to be accessed is provided in its own node, the chipset 102 accesses the memory 103 and when the memory to be accessed is a memory 113 provided in another node 01, the chipset 102 issues a memory access request to a chipset 112 in the node 01 and the chipset 112 accesses the memory 113.

When nodes are to be increased in the conventional way in the system of FIG. 1 which realizes memory interleaving, the throughput of the memory access to each node cannot be uniformed and satisfactory memory interleaving effect cannot be attained unless the nodes are increased in the unit of the power of 2 (2, 4, 8, 16, . . . ) and memories having the same transfer memory and capacity as those of memories provided in an existing system are provided in the nodes to be increased. In the conventional system, in order to uniform the throughput of the memory access to each node, it is necessary to increase at least 2 nodes and the memories provided in the 2 nodes to be increased are required to have the same capacity and transfer speed as those of the memories 103 and 113 provided in the nodes in the system shown in FIG. 1.

In contrast, an example of increasing one node in the existing system shown in FIG. 1 is described as the memory interleaving system according to the embodiment as shown in FIG. 2. In this example, a memory 323 provided in a node 02 to be increased is DDR400/2 GB and has the higher transfer speed and the larger capacity as compared with memories 303 and 313 provided in the nodes in the existing system (“400” in DDR400 MHz/2 GB represents the transfer speed and “2 GB” represents the capacity). In this manner, in the embodiment, the number of nodes to be increased is not limited to the power of 2. The transfer speed and capacity of the node to be increased are required to consider so that the throughput is uniform. It is a matter of course that the node 02 is also provided with a CPU and a chipset. The technical reason that the memory interleaving system can be realized in the configuration example shown in FIG. 2 is now described.

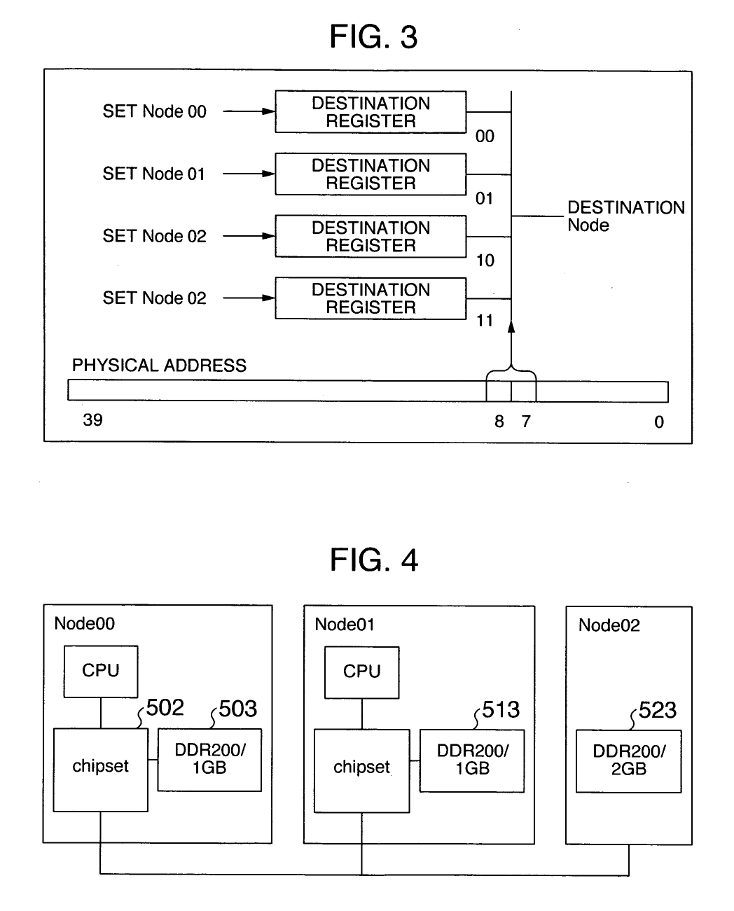

In the embodiment of the present invention, as shown in FIG. 3, destination registers are provided in the chipset 302 and node information is set in the destination registers. The destination registers are used to decide the node provided with the memory to be accessed. As shown in FIG. 2, in the configuration that the memories DDR200/1 GB are provided in the nodes 00 and 01 and the memory DDR400/2 GB is provided in the node 02, the destination registers in the chipset 302 are set as shown in FIG. 3.

More particularly, the node 00 is registered in the destination register 0, the node 01 in the destination register 1, the node 02 in the destination register 2 and the node 02 in the destination register 3. A physical address [8:7], which means bits 8 and 7 of physical address, is used to select the destination register (in this example, the memory interleaving is made in the unit of 128 bytes and accordingly the physical address [8:7] is used). The destination registers 0, 1, 2 and 3 are selected for the physical address [8:7] to be accessed of 00, 01, 10 and 11, respectively.

When the physical address [8:7] is 00, the memory 303 provided in the node 00 is accessed and when the physical address [8:7] is 01, the memory 313 provided in the node 01 is accessed. Further, when the physical address [8:7] is 10 or 11, the memory 323 provided in the node 02 is accessed. In this manner, there are two patterns of the physical addresses by which the memory 323 provided in the node 02 is accessed and the load of the memory access to the node 02 is two times as heavy as that of two other nodes.

Accordingly, in the embodiment of the present invention, the load of the memory access to the node 02 provided with the memory 323 of DDR400/2 GB can be increased and the load of the memory access to the nodes 00 and 01 provided with the memories 303 and 313 of DDR200 MHz/1 GB can be reduced.

As described above, even if the memories having different transfer speed and capacity are mixed in the system, the throughput of the memory access to each node can be uniformed and the satisfactory memory interleaving effect can be attained.

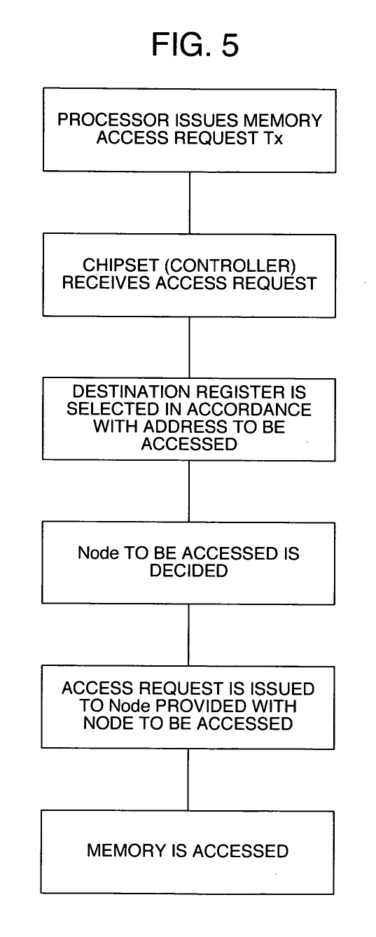

Referring now to the flowchart of FIG. 5, the memory access operation of the memory interleaving system according to the embodiment as described above is described. First, the CPU issues a memory access request Tx and the chipset (controller) in the node in which the CPU is provided receives the access request. Then, a destination register is selected by a designated physical address to be accessed and the node information set in the selected destination register is decided as the destination node as shown in FIG. 3. The node provided with the chipset issues an access request to the node provided with the memory to be accessed and the memory is accessed.

In the configuration example shown in FIGS. 2 and 3, when the physical address is required in order of “00”, “01”, “10” and “11”, the throughput for the node 02 (its transfer speed and capacity are twice as large as those of the nodes 00 and 01) is uniform and the memory interleaving effect is maximized. This order can be designated by the processor CPU.

Referring now to FIG. 4, another example of increasing one node in the memory interleaving system according to the embodiment is described. In this example, the node increased is provided with a memory 523 of DDR200 MHz/2 GB. Even in this case, destination registers are provided in a chipset 502 and are set in the same manner as shown in FIG. 3. The example of FIG. 4 premises that the node 02 increased uses the DDR having the same transfer speed (the capacity is double).

In the configuration shown in FIGS. 4 and 3, the load of the memory access to the node 02 (its memory capacity is twice as large as that of the node 00 or 01 and its transfer speed is the same) having the increased capacity of memory to be provided therein is increased (the access load on the node 02 is twice as heavy as that on the node 00 or 01). Further, in the node 02, the memory interleaving of 1GB +1GB is made (the whole memory of 2 GB is divided in two memory blocks each having 1 GB to realizes the memory interleaving between the two memory blocks) to thereby make it possible to increase the throughput of the memory access in the node 02 and use the memories effectively.

As described above, the throughput of the memory access to the nodes 00 and 01 provided with the memories 503 and 513 of 1 GB and the node 02 provided with the memory 523 of 2 GB can be uniformed to attain the satisfactory memory interleaving effect. In other words, the node increased shown in FIG. 4 uses the memory having the same transfer speed and the double capacity (the node 02 increased uses the equivalent memory to that of the node 00 or 01 with the exception that the capacity thereof is different) and in addition the memory in the node 02 is divided into blocks to realize the memory interleaving between the blocks, so that the throughput is increased. Further, since the node 02 increased shown in FIG. 2 has the faster transfer speed, the memory interleaving system between its internal memory blocks is not required.

As described above, in the memory interleaving system according to the embodiment of the present invention, the plurality of destination registers are provided and the node information is registered in the destination registers. The destination register is selected in accordance with the physical address to be accessed to thereby decide the node provided with the memory to be accessed. The load of the memory access to each node can be changed in accordance with how to set the node information in the destination registers.

The load of the memory access to the node provided with the memory having the increased transfer speed and capacity can be increased and the load of the memory access to the node provided with the memory having the reduced transfer speed and capacity can be reduced to thereby uniform the throughput of the memory access to each node. In other words, even if memories having the different capacity and transfer speed are mixed in the system, the throughput of the memory access to each node can be uniformed and even one node can be increased. That is, an odd number of nodes can be increased.

Further, the memories provided in the node to be increased are not limited to those having the same transfer speed and capacity in the prior art and even when the memory having the different data transfer speed such as DDR memories 200 and 400 MHz having the high-speed access time is provided in the nodes or even when the memory having the different capacity is provided in each node, the throughput of the memory access to each node can be uniformed and the satisfactory memory interleaving effect can be attained. Accordingly, the memory interleaving having the high flexibility in the increase of node and the memory structure can be realized.

It should be further understood by those skilled in the art that although the foregoing description has been made on embodiments of the invention, the invention is not limited thereto and various changes and modifications may be made without departing from the spirit of the invention and the scope of the appended claims.

1. A computer system for making memory interleaving among a plurality of nodes, wherein
said nodes each comprise a CPU, a memory and a controller for controlling transmission and reception of data between said CPU and said memory and between each node and outside, and
said controller of each node comprises a plurality of destination registers for setting node information for said plurality of nodes containing its own node and a selector for selecting one of said plurality of destination registers in accordance with a memory address of a memory access request issued by said CPU of its own node, said memory access request being issued to said node selected by said selector.

2. A computer system according to claim 1, wherein
when a node provided with a memory having transfer speed and capacity different from those of a memory provided in an existing node is increased, said controller controls setting of said node information for said increased node in said destination register to thereby uniform throughput of memory access to each node containing said increased node.

3. A computer system according to claim 2, wherein
when a node provided with a memory having transfer speed and capacity both increased N times as that of said existing node is increased, the controller sets node information for said increased node in N destination registers where N being an integer.

4. A computer system according to claim 2, wherein
when a node provided with a memory having transfer speed and capacity both increased twice as that of said existing node is increased, said controller sets node information for said increased node in two destination registers.

5. A computer system according to claim 2, wherein
said memory provided in said existing node is DDR200/1 GB and said memory provided in said increased node is DDR400/2 GB.

6. A computer system according to claim 2, wherein said increased node is odd in number.

7. A computer system according to claim 2, wherein said increased node is one in number.

8. A computer system according to claim 1, wherein said node information is a node number.

9. A computer system according to claim 1, wherein nodes having different transfer speed and capacity of memory are mixed in said nodes.

10. A computer system according to claim 1, wherein
when a node provided with a memory having capacity different from that of a memory provided in an existing node is increased, said controller controls setting of said node information for said increased node in said destination register to thereby uniform throughput of memory access to each node containing said increased node.

11. A computer system according to claim 10, wherein
when a node provided with a memory having capacity increased N times is increased, said controller sets node information for said increased node in N destination registers.

12. A computer system according to claim 10, wherein
when a node provided with a memory having capacity increased twice is increased, said controller sets node information for said increased node in two destination registers.

13. A computer system according to claim 10, wherein
said memory provided in said existing node is DDR200/1 GB and said memory provided in said increased node is DDR400/2 GB.

14. A computer system according to claim 10, wherein memory interleaving is made in said increased node.

15. A computer system according to claim 1, wherein nodes having different capacity of memory are mixed in said nodes.
